(19) United States
(12) Patent Application Publication
(10) Pub. No.: US 2007/0194994 A1
(43) Pub. Date: Aug. 23, 2007

(54) Extendible mobile slot antenna apparatus, systems, and methods

(76) Inventor: Alan E. Waltho, San Jose, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/359,792

(22) Filed: Feb. 22, 2006

(51) Int. Cl. H01Q 1/24; H01Q 13/10

(52) U.S. Cl. 343/702; 343/767

(57) ABSTRACT

Embodiments of an extendible slot antenna for incorporation into a portable electronic device are described generally herein. Other embodiments may be described and claimed.

### TECHNICAL FIELD

Various embodiments described herein relate to electronic communications generally, including apparatus, systems, and methods associated with radio-frequency antennas for use in portable electronic devices.

### BACKGROUND INFORMATION

Rabbit-ear or monopole antenna types may be used for reception, including perhaps channelized radio and television reception, at a portable electronic device. However, such antennas may have a narrow bandwidth for any specific length or orientation, and may experience sharp nulls along an axis of extension when used to receive horizontally polarized signals. Good reception may require that a user adjust an antenna length and orientation when changing channels or when a spatial orientation of the portable electronic device changes relative to a received signal as the user moves about.

However, determining an optimum length and direction may require that the user judge a received audio quality or observe a received picture quality while manipulating the antenna. Digital radio and television may experience a rapid decrease in signal coherency as a bit error rate associated with a received bit stream increases. Consequently, acquiring and maintaining a weak digital radio or television signal by manipulating an antenna length and orientation in a mobile environment may be particularly difficult.

### BRIEF DESCRIPTION OF THE DRAWINGS

FIG. 1 is a block diagram of an apparatus and a representative system according to various embodiments.

FIG. 2 is a flow diagram illustrating several methods according to various embodiments.

FIG. 3 is a block diagram of an article according to various embodiments.

### DETAILED DESCRIPTION

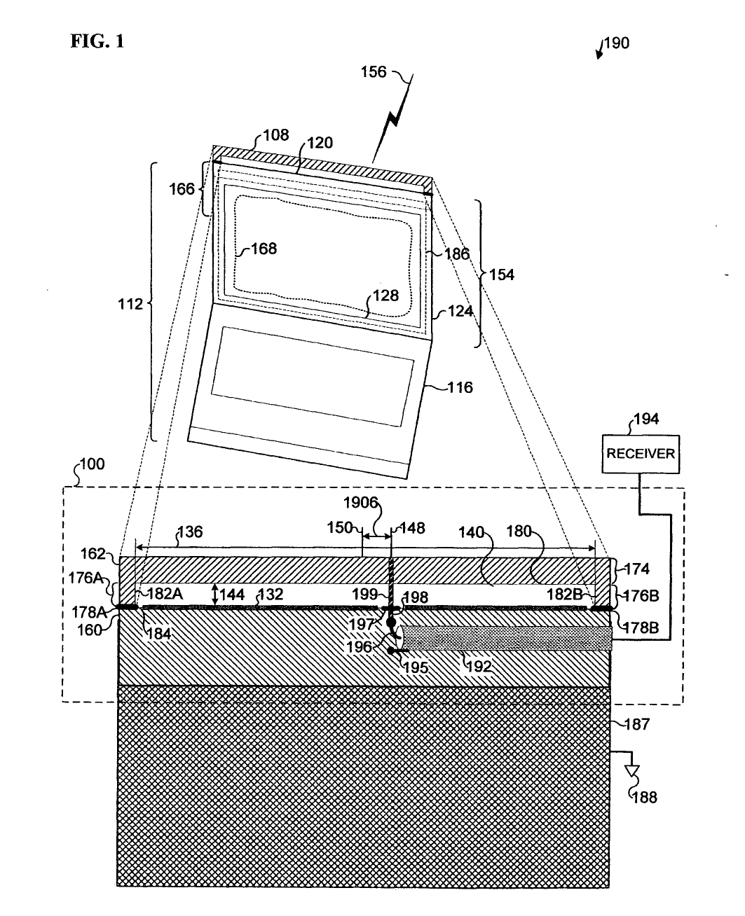

FIG. 1 comprises a block diagram of an apparatus 100 and a system 190 according to various embodiments of the invention. An extendible slot antenna 108 may be incorporated into a portable electronic device 112. The portable electronic device 112 may advantageously utilize a nearly omnidirectional reception pattern and broadband resonance associated with the extendible slot antenna 108. These characteristics may contribute to an enhanced user experience for digital radio or television reception at the portable electronic device 112, and may enable the user to avoid having to make antenna adjustments.

The portable electronic device 112 may comprise a laptop computer 116, among other examples (e.g., cellular telephone, handheld computer, digital audio player (MP3 player), etc.). Although various embodiments may be described herein relative to the laptop computer 116, the extendible slot antenna 108 may be utilized with other portable electronic devices. Another example of a portable electronic device that may comprise an embodiment of the invention is a portable combination video disk player and digital television receiver.

The extendible slot antenna 108 may be rotated or otherwise extended outward into a deployed position at a top 120 of a housing component 124 surrounding a display 128 associated with the laptop computer 116. Some embodiments may use conductive hinges or sliding contacts for this purpose. Some rotatively extendible embodiments may use a non-conducting flexible hinge 132 for added strength. The latter hinge may comprise plastic, cloth, or other flexible non-conductive material, without limitation.

A primary resonance of the extendible slot antenna 108 may be determined by a length 136 of a slot 140 and by a dielectric material used to fill the slot 140. The length 136 of the slot 140 associated with a one-half wavelength embodiment of the extendible slot antenna 108 may be selected such that the antenna 108 is resonant within a chosen band of frequencies. In some embodiments, the chosen band of frequencies may be associated with a broadcast television band. The broadcast television band may comprise a set of channelized frequencies between 470 megahertz and 700 megahertz in the United States of America. Other slot lengths may be selected as appropriate for other frequency bands.

A greater bandwidth at the primary resonance is obtained by decreasing the permittivity of the dielectric material and by increasing a width 144 of the slot 140. Some embodiments may utilize an FR4 laminate material to obtain satisfactory slot geometries and bandwidths. FR4 laminate is an epoxy resin base material from which plated-through-hole and multilayer printed circuit boards are often constructed. “FR” means Flame Retardant, and Type “4” indicates woven glass reinforced epoxy resin. FR4 laminate displays a dielectric constant of 4.7 at 1.0 megahertz. Other dielectric materials may be used.

Higher-order resonances may be tuned to desired bands by offsetting a feed position 148 from a center position 150 along the length 136 of the slot 140. Desirable second and third order resonant frequencies may comprise 1.6 gigahertz and 2.2 gigahertz, respectively. The latter frequencies may be useful for a reception of a satellite transmission of digital radio or television, for example. As described in further detail below, the apparatus, systems, and methods described herein may provide a storable, low-profile extendible mobile slot antenna.

The apparatus 100 may thus include the extendible slot antenna 108, adapted for attachment to a display section 154 of the laptop computer 116 to enable reception of a transmitted signal 156.

The extendible slot antenna 108 may comprise a first conductive sheet 160 and a second conductive sheet 162. The first conductive sheet 160 may be substantially coplanar with a broad side 168 of the display section 154 of the laptop computer 116. The first conductive sheet 160 may extend horizontally across a top portion 166 of the broad side 168 of the display section 154, as the display section 154 is seen when deployed for viewing.

The second conductive sheet 162 may also extend horizontally across the top portion 166 of the broad side 168 of the display section 154. The second conductive sheet 162 may be extendibly coupled to the first conductive sheet 160. When extended, the second conductive sheet 162 may be substantially coplanar with both the first conductive sheet 160 and with the broad side 168 of the display section 154. The slot 140 may be formed between the first conductive sheet 160 and the second conductive sheet 162 when the second conductive sheet 162 is extended.

The second conductive sheet 162 may comprise a horizontally elongated portion 174 extending horizontally across the top portion 166 of the broad side 168 of the display section 154. The second conductive sheet 162 may also comprise perpendicular extensions 176A and 176B at each end of the horizontally elongated portion 174. The second conductive sheet 162 may be coupled to the first conductive sheet 160 at coupling members 178A and 178B associated with the perpendicular extensions 176A and 176B, respectively. When the extendible slot antenna 108 is extended, the slot 140 may be formed within an area bounded by a lower edge 180 of the horizontally elongated portion 174 of the second conductive sheet 162, inner edges 182A and 182B of the perpendicular extensions 176A and 176B, respectively, and a top edge 184 of the first conductive sheet 160.

In some embodiments, the coupling members 178A and 178B may comprise conductive hinges. The conductive hinges may couple the second conductive sheet 162 to the first conductive sheet 160 such that the second conductive sheet 162 is capable of swiveling to a rotatively deployed position substantially coplanar with the first conductive sheet 160. The second conductive sheet 162 may also be capable of swiveling through an angle of between, for example, 90 and 180 degrees from the rotatively deployed position to a rotatively stowed position. The second conductive sheet 162 may swivel forward toward the viewer and downward for storage in some embodiments. In other embodiments the second conductive sheet 162 may swivel backward and downward, toward a rear cover of the display section 154, for storage.

In some embodiments, the second conductive sheet 162 may be capable of being pulled out and pushed back in by a user of the portable electronic device 112. The coupling members 178A and 178B may comprise sliding contacts. The sliding contacts may couple the second conductive sheet 162 to the first conductive sheet 160 such that the second conductive sheet 162 is capable of extending from a recessed position adjacent the first conductive sheet 160. The second conductive sheet 162 may extend to a deployed position substantially coplanar with the first conductive sheet 160 and extending upward therefrom.

The first conductive sheet 160 may be located within or upon the housing component 124 associated with the display section 154. In some embodiments, the first conductive sheet 160 may be affixed to a broad side of the housing component 124. In some embodiments, the first conductive sheet 160 may be affixed to a planar component 186 within the display section 154. The planar component 186 may lie substantially coplanar with the display section 154. The planar component 186 may comprise a printed circuit board, for example.

In some embodiments, the first conductive sheet 160 may be electrically connected to a ground plane 187 associated with the display section, or may be positioned adjacent to the ground plane 187. Example embodiments of the ground plane 187 may include a conductive coating on or within the housing component 124, and a layer on the planar component 186, among others. The ground plane 187 may be electrically connected to a chassis ground 188 associated with the laptop computer 116.

In another embodiment, a system 190 may include one or more of the apparatus 100, as previously described. The system 190 may also include a cable 192 coupled to the extendible slot antenna 108. The cable 192 may comprise a coaxial cable, a twinlead, a twisted pair cable, a direct probe feed, or a microstrip feed, among other types. The cable 192 may feed a signal from the extendible slot antenna 108 to a receiver 194 associated with the laptop computer 116.

In some embodiments, a first conductor 195 associated with the cable 192 may be connected to the first conductive sheet 160. The first conductor 195 may be connected to the first conductive sheet 160 at the feed position 148 along the length 136 of the slot 140. A second conductor 196 may also be associated with the cable 192. The second conductor 196 may be connected to the second conductive sheet 162 at the feed position 148, perhaps via a conductive hinge 197.

In some embodiments, the second conductor 196 may be connected to a first feed contact 198 fixed relative to the first conductive sheet 160. The first feed contact 198 may be in sliding contact with a second feed contact 199 extending from the second conductive sheet 162 at the feed position 148 along the length 136 of the slot 140.

In some embodiments, the feed position 148 may be offset from the center position 150 along the length 136 of the slot 140. An offset 1906 may be calculated to produce a secondary resonance at a secondary resonant frequency and/or a tertiary resonance at a tertiary resonant frequency. Some embodiments may be tuned via the offset 1906 such that the secondary resonant frequency lies at approximately 1.6 gigahertz and/or the tertiary resonant frequency lies at approximately 2.2 gigahertz.

One or more of the components previously described may be implemented, emulated, or simulated in a number of ways, including embodiments in software, firmware, and/or hardware. Thus, the apparatus 100; the extendible slot antenna 108; the portable electronic device 112; the laptop computer 116; the top 120; the housing component 124; the display 128; the flexible hinge 132; the length 136; the slot 140; the width 144; the feed position 148; the center position 150; the display section 154; the transmitted signal 156; the conductive sheets 160, 162; the top portion 166; the broad side 168; the horizontally elongated portion 174; the perpendicular extensions 176A, 176B; the coupling members 178A, 178B; the lower edge 180; the inner edges 182A, 182B; the top edge 184; the planar component 186; the ground plane 187; the chassis ground 188; the system 190; the cable 192; the receiver 194; the conductors 195, 196; the conductive hinge 197; the feed contacts 198, 199; and the offset 1906 may all be characterized as “modules” herein.

The modules may include hardware circuitry, single or multi-processor circuits, memory circuits, software program modules and objects, firmware, and combinations thereof, as desired by the architect of the apparatus 100 and the system 190 and as appropriate for particular implementations of various embodiments.

The apparatus and systems of various embodiments may be useful in applications other than receiving commercial broadcasts at a portable electronic device. Thus, various embodiments of the invention are not to be so limited. The illustrations of the apparatus 100 and the system 190 are intended to provide a general understanding of the structure of various embodiments. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, multi-core processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.), set top boxes, and others. Some embodiments may include a number of methods.

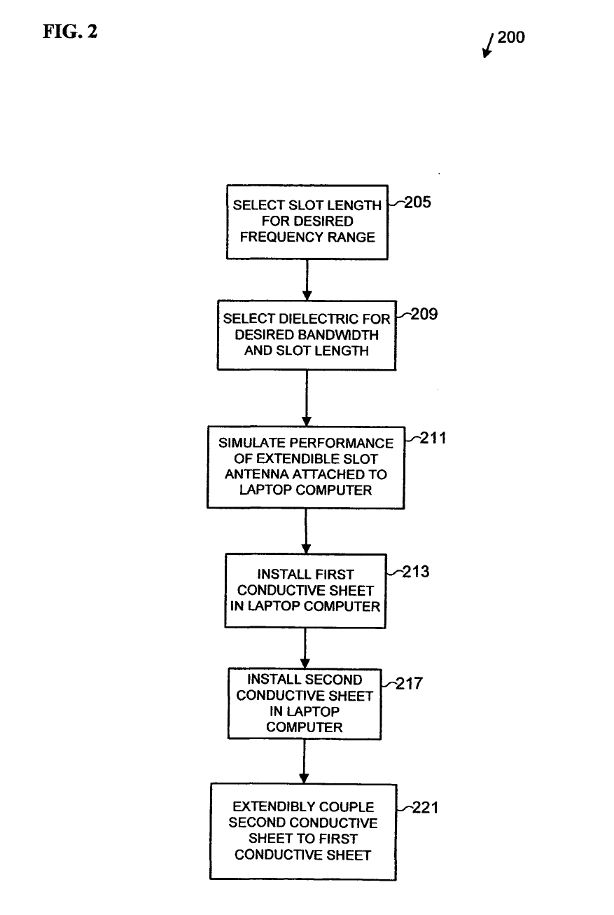

FIG. 2 is a flow diagram illustrating several methods according to various embodiments. A method 200 may include activities associated with designing and testing an extendible slot antenna for use in a laptop computer. The method 200 may also include incorporating the extendible slot antenna into a display section of the laptop computer. The extendible slot antenna may comprise structures as previously described.

The method 200 may commence at block 205 with selecting a length of a slot associated with a one-half wavelength embodiment of the extendible slot antenna. The length of the slot may be selected such that a resonant frequency associated with the extendible slot antenna lies within a chosen band of frequencies. The chosen band of frequencies may include a commercial television band, among other target bands.

The method 200 may continue at block 209 with selecting a dielectric material to incorporate within the slot associated with the extendible slot antenna. The dielectric material may be selected such that a bandwidth associated with the extendible slot antenna extends across the chosen band of frequencies. In one example, the slot length and dielectric material may be chosen to obtain a bandwidth extending from approximately 470 megahertz to approximately 700 megahertz. An additional selection criteria associated with the dielectric material may be that of achieving a desired slot length in a one-half wavelength embodiment of the extendible slot antenna. For example, a target slot length associated with a laptop computer may fall within a range of approximately 20 centimeters to approximately 35 centimeters.

The method 200 may also include simulating a performance of the extendible slot antenna attached to the display section of the laptop computer, at block 211.

A first conductive sheet may be installed in the laptop computer to lie substantially coplanar with a broad side of the display section of the laptop computer, at block 213. The first conductive sheet may extend horizontally across a top portion of the broad side of the display section as the display section is seen when deployed for viewing, as previously described. The method 200 may also include installing a second conductive sheet to extend horizontally across the top portion of the broad side of the display section, at block 217.

The method 200 may conclude at block 221 with extendibly coupling the second conductive sheet to the first conductive sheet. The first and second conductive sheets may be coupled such that the second conductive sheet is substantially coplanar with both the first conductive sheet and with the broad side of the display section when the second conductive sheet is extended. A slot associated with the extendible slot antenna may be formed between the first conductive sheet and the second conductive sheet when the second conductive sheet is extended.

It may be possible to execute the activities described herein in an order other than the order described. And, various activities described with respect to the methods identified herein can be executed in repetitive, serial, or parallel fashion. Further, while the above example is described in connection with a laptop computer, the apparatus, systems, and methods described herein may be readily applicable to other electronic devices including a cellular telephone, a handheld computer, a digital audio player, etc.

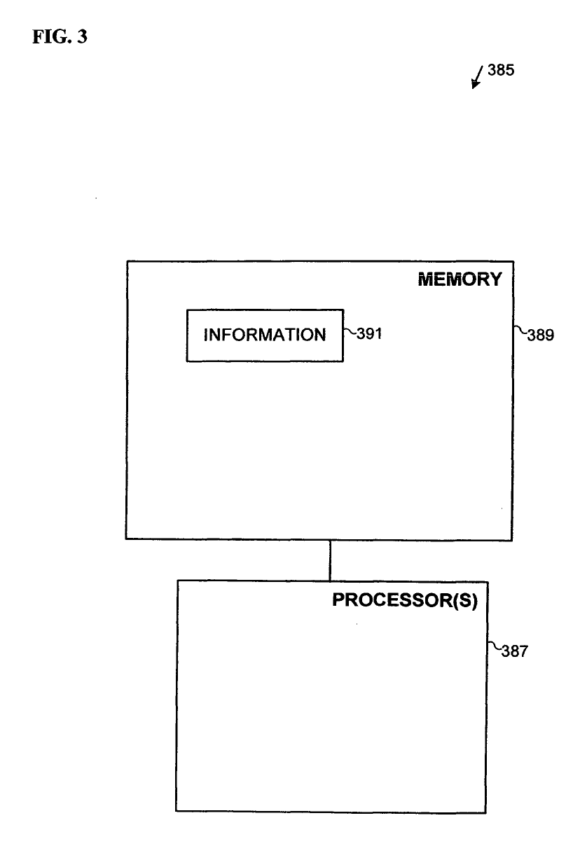

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment. Thus, other embodiments may be realized, as discussed regarding FIG. 3 below.

FIG. 3 is a block diagram of an article 385 according to various embodiments of the invention. Examples of such embodiments may comprise a computer, a memory system, a magnetic or optical disk, some other storage device, or any type of electronic device or system. The article 385 may include one or more processor(s) 387 coupled to a machine-accessible medium such as a memory 389 (e.g., a memory including electrical, optical, or electromagnetic elements). The medium may contain associated information 391 (e.g., computer program instructions, data, or both) which, when accessed, results in a machine (e.g., the processor(s) 387) performing the activities previously described.

Implementing the apparatus, systems, and methods disclosed herein may advantageously utilize a nearly omnidirectional reception pattern and broadband resonance associated with an extendible slot antenna incorporated into a portable electronic device. These characteristics may contribute to an enhanced user experience for digital radio or television reception at the portable electronic device, and may enable the user to avoid having to make antenna adjustments.

Although the inventive concept may include embodiments described in the exemplary context of an Institute of Electrical and Electronic Engineers (IEEE) standard 802.xx implementation (e.g., 802.11, 802.11a, 802.11b, 802.11E, 802.11g, 802.16, etc.), the claims are not so limited. Additional information regarding the IEEE 802.11 standard may be found in “ANSI/IEEE Std. 802.11, Information technology—Telecommunications and information exchange between systems—Local and metropolitan area networks—Specific requirements—Part 11: Wireless LAN Medium Access Control (MAC) and Physical Layer (PHY) Specifications” (published 1999; reaffirmed June 2003). Additional information regarding the IEEE 802.11a protocol standard may be found in IEEE Std 802.11a, Supplement to IEEE Standard for Information technology—Telecommunications and information exchange between systems—Local and metropolitan area networks—Specific requirements Part 11: Wireless LAN Medium Access Control (MAC) and Physical Layer (PHY) specifications—High-speed Physical Layer in the 5 GHz Band (published 1999; reaffirmed Jun. 12, 2003). Additional information regarding the IEEE 802.11b protocol standard may be found in IEEE Std 802.11b, Supplement to IEEE Standard for Information technology—Telecommunications and information exchange between systems—Local and metropolitan area networks—Specific requirements-Part 11: Wireless LAN Medium Access Control (MAC) and Physical Layer (PHY) specifications: Higher-Speed Physical Layer Extension in the 2.4 GHz Band (approved Sep. 16, 1999; reaffirmed Jun. 12, 2003). Additional information regarding the IEEE 802.11E standard may be found in “IEEE 802.11E Standard for Information technology—Telecommunications and information exchange between systems—Local and metropolitan area networks—Specific requirements Part 11: Wireless LAN Medium Access Control (MAC) and Physical Layer (PHY) specifications: Amendment 8: Medium Access Control (MAC) Quality of Service Enhancements (published 2005). Additional information regarding the IEEE 802.11g protocol standard may be found in IEEE Std 802.11g™, IEEE Std 802.11g™, IEEE Standard for Information technology—Telecommunications and information exchange between systems—Local and metropolitan area networks—Specific requirements Part 11: Wireless LAN Medium Access Control (MAC) and Physical Layer (PHY) specifications Amendment 4: Further Higher Data Rate Extension in the 2.4 GHz Band (approved Jun. 12, 2003). Additional information regarding the IEEE 802.16 protocol standard may be found in IEEE Standard for Local and Metropolitan Area Networks—Part 16: Air Interface for Fixed Broadband Wireless Access Systems (published Oct. 1, 2004).

Embodiments of the present invention may be implemented as part of any wired or wireless system. Examples may also include embodiments comprising multi-carrier wireless communication channels (e.g., orthogonal frequency division multiplexing (OFDM), discrete multitone (DMT), etc.) such as may be used within a wireless personal area network (WPAN), a wireless local area network (WLAN), a wireless metropolitan are network (WMAN), a wireless wide area network (WWAN), a cellular network, a third generation (3G) network, a fourth generation (4G) network, a universal mobile telephone system (UMTS), and like communication systems, without limitation.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, including:
an extendible slot antenna for attachment to a display section of a portable electronic device (PED) to enable reception of a transmitted signal, the extendible slot antenna comprising:
a first conductive sheet; and
a second conductive sheet extendibly coupled to the first conductive sheet.

2. The apparatus of claim 1, wherein:
the first conductive sheet is substantially coplanar with a broad side of the display section of the PED, the first conductive sheet extending horizontally across a top portion of the broad side of the display section as the display section is seen when deployed for viewing; and
the second conductive sheet extends horizontally across the top portion of the broad side of the display section, wherein the second conductive sheet is extendibly coupled to the first conductive sheet such that the second conductive sheet is substantially coplanar with both the first conductive sheet and with the broad side of the display section when the second conductive sheet is extended, and wherein a slot associated with the extendible slot antenna is formed between the first conductive sheet and the second conductive sheet when the second conductive sheet is extended.

3. The apparatus of claim 2, wherein the second conductive sheet comprises:
a horizontally elongated portion extending horizontally across the top portion of the broad side of the display section; and
a perpendicular extension at each end of the horizontally elongated portion to extendibly couple the second conductive sheet to the first conductive sheet at a coupling member associated with each perpendicular extension such that the slot associated with the extendible slot antenna is formed within an area bounded by a lower edge of the horizontally elongated portion of the second conductive sheet, an inner edge of each perpendicular extension, and a top edge of the first conductive sheet when the extendible slot antenna is extended.

4. The apparatus of claim 3, wherein the coupling member comprises a conductive hinge to extendibly couple the second conductive sheet to the first conductive sheet such that the second conductive sheet is capable of swiveling to a rotatively deployed position substantially coplanar with the first conductive sheet and is capable of swiveling through an angle of between 90 and 180 degrees from the rotatively deployed position to a rotatively stowed position.

5. The apparatus of claim 3, wherein the coupling member comprises a sliding contact to extendibly couple the second conductive sheet to the first conductive sheet such that the second conductive sheet is capable of extending outward from a recessed position adjacent the first conductive sheet to a deployed position substantially coplanar with the first conductive sheet and extending upward therefrom.

6. The apparatus of claim 2, wherein the first conductive sheet is affixed to a housing component associated with the display section.

7. The apparatus of claim 2, wherein the first conductive sheet is affixed to a planar component within the display section, the planar component substantially coplanar with the display section.

8. The apparatus of claim 7, wherein the planar component comprises a printed circuit board.

9. The apparatus of claim 2, wherein the first conductive sheet is electrically connected to a ground plane associated with the display section.

10. The apparatus of claim 2, wherein the first conductive sheet is positioned adjacent a ground plane associated with the display section.

11. The apparatus of claim 2, further including:
a dielectric material incorporated within the slot associated with the extendible slot antenna.

12. The apparatus of claim 11, wherein the dielectric material comprises an FR4 laminate material.

13. A system, including:
an extendible slot antenna for attachment to a display section of a portable electronic device (PED) to enable reception of a transmitted signal; and
a coaxial cable coupled to the extendible slot antenna to feed a signal from the extendible slot antenna to a receiver associated with the PED.

14. The system of claim 13, further including:
a first conductive sheet substantially coplanar with a broad side of the display section of the PED, the first conductive sheet extending horizontally across a top portion of the broad side of the display section as the display section is seen when deployed for viewing; and
a second conductive sheet extending horizontally across the top portion of the broad side of the display section, wherein the second conductive sheet is extendibly coupled to the first conductive sheet such that the second conductive sheet is substantially coplanar with both the first conductive sheet and with the broad side of the display section when the second conductive sheet is extended, and wherein a slot associated with the extendible slot antenna is formed between the first conductive sheet and the second conductive sheet when the second conductive sheet is extended.

15. The system of claim 14, wherein a length of the slot associated with a one-half wavelength embodiment of the extendible slot antenna is selected such that the antenna is resonant within a chosen band of frequencies.

16. The system of claim 15, wherein the chosen band of frequencies comprises a broadcast television band.

17. The system of claim 16, wherein a first conductor associated with the coaxial cable is connected to the first conductive sheet at a feed position along a length of the slot, and a second conductor associated with the coaxial cable is connected to the second conductive sheet at the feed position along the length of the slot.

18. The system of claim 16, wherein a first conductor associated with the coaxial cable is connected to the first conductive sheet at a feed position along a length of the slot, wherein a second conductor associated with the coaxial cable is connected to a first feed contact fixed relative to the first conductive sheet, and wherein the first feed contact is in sliding contact with a second feed contact extending from the second conductive sheet at the feed position along the length of the slot.

19. The system of claim 16, wherein a feed position along a length of the slot is offset from a center position along the length of the slot by a distance calculated to produce a secondary resonance at a secondary resonant frequency and a tertiary resonance at a tertiary resonant frequency.

20. The system of claim 19, wherein the secondary resonant frequency is approximately 1.6 gigahertz and the tertiary resonant frequency is approximately 2.2 gigahertz.

21. A method, including:
incorporating an extendible slot antenna into a display section of a portable electronic device (PED).

22. The method of claim 21, further including:
installing a first conductive sheet in the PED to lie substantially coplanar with a broad side of the display section of the PED, wherein the first conductive sheet extends horizontally across a top portion of the broad side of the display section as the display section is seen when deployed for viewing; and
installing a second conductive sheet to extend horizontally across the top portion of the broad side of the display section;
extendibly coupling the second conductive sheet to the first conductive sheet such that the second conductive sheet is substantially coplanar with both the first conductive sheet and with the broad side of the display section when the second conductive sheet is extended, and wherein a slot associated with the extendible slot antenna is formed between the first conductive sheet and the second conductive sheet when the second conductive sheet is extended.

23. The method of claim 21, further including:
selecting a length of a slot associated with a one-half wavelength embodiment of the extendible slot antenna such that a resonant frequency associated with the extendible slot antenna lies within a chosen band of frequencies.

24. The method of claim 23, further including:
selecting a dielectric material to incorporate within the slot associated with the extendible slot antenna such that a bandwidth associated with the extendible slot antenna extends across the chosen band of frequencies.

25. The method of claim 21, further including:
simulating a performance of the extendible slot antenna attached to the PED.
